(19) United States
(12) Patent Application Publication
(10) Pub. No.: US 2018/0304221 A1
(43) Pub. Date: Oct. 25, 2018

(54) TEXTURED COMPOSITIONS, METHODS, AND SYSTEMS FOR CAPTURING AND RETAINING BIOMOLECULES

(71) Applicant: 3dbiosurfaces Technologies, LLC, Tucson, AZ (US)

(72) Inventors: Alan Gordon GOODYEAR, Tucson, AZ (US); Barry BEROTH, Tucson, AZ (US)

(21) Appl. No.: 15/770,299

(22) PCT Filed: Oct. 21, 2016
(86) PCT No.: PCT/US2016/058273

§ 371 Date: Apr. 23, 2018

Related U.S. Application Data
(60) Provisional application No. 62/244,947, filed on Oct. 22, 2015.

(51) Int. Cl. B01J 19/00

(52) U.S. Cl. CPC B01J 19/0046; B01J 2219/00637; B01J 2219/00635; B01J 2219/00317

(57) ABSTRACT

An activated textured surface comprising a plurality of energetic moieties adapted to bind biomolecules on microfeatures and/or microstructures of the activated textured surface. The microfeatures and/or microstructures provide an increase in surface area. The activated textured surface may comprise microstructures without microfeatures, or in some cases, microstructures are disposed in and/or between at least a portion of the microfeatures. The activated textured surface may be a part of a microarray substrate. Activation of the surface molecules of the microfeatures and/or microstructures using electromagnetic radiation or plasma may be used to create the energetic moieties on the activated textured surface.

CROSS REFERENCE

This application claims priority to U.S. patent application Ser. No. 62/244,947, filed Oct. 22, 2015, the specification(s) of which is/are incorporated herein in their entirety by reference.

### FIELD OF THE INVENTION

The present invention relates to textured surfaces, such as textured surfaces on microarray substrates, wherein the textured surface is treated or activated so as to display energetic moieties on its surface, wherein the moieties are capable of capturing and/or retaining biomolecules. In some cases, all, substantially all, or most of the surface area with energetic moieties can become occluded with the biomolecules.

### BACKGROUND OF THE INVENTION

The surfaces of flat substrates are commonly used to attach biomolecules (probes) for the purpose of determining the nature and properties of other biomolecules (targets). Typically, substrates comprise a flat, relatively smooth substrate (e.g., glass or derivative thereof, polymer substrates, etc.), such as slides, microarray substrates, multi-well plates, and the like.

The most common method for capturing and retaining biomolecules to the flat substrate involves coating the substrate with a linker molecule (e.g., a silane derivative in the presence of water, etc.) that has one terminal end designed to adhere (e.g., covalently) to the substrate surface and a second terminal end designed to link (e.g., covalently, electrostatically, ionically) to the biomolecule (e.g., probe) that is to be captured on the substrate, e.g., for use in various assays such as microarrays, etc.

The preparation of the flat substrate with the linker molecule and biomolecule (e.g., probe) often requires two stages. The first stage typically involves subjecting the bare, flat substrate to a solution-based or vapor-based coating with the linker molecule. In the case of solution-based coating, the linker molecule is dissolved in a solvent solution in which the bare, flat substrate is immersed. When removed from the solution and allowed to dry, a layer of the linker molecule coats the substrate. Evaporating the linker molecule and exposing the flat substrate to the vapor is also used to produce similar coatings. This version of the coating process is often completed in a vacuum environment and at some elevated temperature.

The second stage of substrate preparation involves attachment of the biomolecule (e.g., probe) to the linker molecule. Often, the probe comprises a DNA molecule, an RNA molecule, a peptide, an antibody, or the like, and may have a known identity. One or more biomolecules (e.g., probes) are usually placed using known methods in distinct and separate areas of a grid on the substrate (with linker molecules). The probes then become available for exposure to other biomolecules (targets), wherein one or more targets may bind to one or more probes. Subsequent analysis may permit the properties of the target(s) to be inferred from the interactions with the probe(s).

The aforementioned methods pertain to the preparation of flat substrates. Those in the art have had a preference for using flat surfaces because the lenses on the cameras (microscopes) used for analyses worked best with the flattest surfaces, and because of uncertainty as to the uniformity of biomolecule binding to surfaces that were not flat. Despite the preference for flat surfaces, Inventors attempted to use textured surfaces (e.g., textured surfaces in/on microarray substrates). As used herein, a textured substrate or textured surface refers to a surface with microfeatures that increase the surface area of the surface. A textured surface may also have smaller microstructures in or between (or both in and between) various microfeatures, wherein the microstructures further increase the surface area of the surface. (Or, the textured surface may have microstructures without microfeatures.) Inventors expected that the textured surfaces would have increased biomolecule binding compared to flat surfaces because the textured surface would have more surface area than a flat surface.

However, experiments with textured surfaces using the aforementioned methods for attaching biomolecule probes (via linker molecules) showed that a significant fraction of the increased surface area associated with the textured surface (e.g., the microfeatures, microstructures) was not participating in the binding of the probes. Example 1 and Example 2 below describe experiments wherein textured slides were dip coated or vapor coated with a silane solution, respectively, and subsequently printed with oligonucleotides. Analysis of the images of the slides was inconsistent and disappointing, showing that the textured substrates exhibited only a minor improvement in intensity (detection of probes) when compared to non-textured, flat substrates. (Without wishing to limit the present invention to any theory or mechanism, it was hypothesized that the aforementioned methods coated the textured surface so thickly that the microfeatures and microstructures of the textured surface were covered, negating the increased surface area of the textured surface.)

Inventors surprisingly found that treatment of textured surfaces with electromagnetic radiation (e.g., ultraviolet (UV) light) or plasma (a highly ionized gas that is highly energetic) allowed for biomolecule binding to the textured surface without the use of a linker (e.g., silane molecule) and the benefit of the high surface area associated with the textured surface was realized: there was a significant increase in biomolecule binding on a textured surface treated with UV or plasma (as described herein, e.g., see Example 3 and Example 4) as compared to flat surfaces subjected to the same treatment. This was surprising for many reasons. Firstly, despite UV and plasma having been used for treating flat surfaces, it was not expected that the physics would translate to a much smaller scale for a textured surface. And, it was not expected that the activation of the textured surface would be uniform. Also, bare plastic is not normally a good surface for depositing oligonucleotides, which is why those in the art use the silane process (as described above) to bind biomolecules on plastic surfaces (e.g. to bind the probe via a linker molecule). Indeed, for a flat surface, a thicker silane layer is better for consistent results. However as previously discussed, a thicker layer of silane negates the value of the higher surface area of a textured surface.

### SUMMARY OF THE INVENTION

As previously discussed, Inventors surprisingly discovered methods for attaching biomolecules to textured surfaces. As used herein, a textured substrate or textured surface refers to a surface with microfeatures and/or smaller microstructures that increase the surface area of the surface. For example, a textured substrate may comprise microfeatures without microstructures, microstructures without microfeatures, or both microfeatures and microstructures. In some embodiments, the microstructures may be in/on or between (or both in/on and between) the microfeatures (see FIG. 1A, FIG. 1B, FIG. 1C, FIG. 1D, FIG. 1E, FIG. 2A, FIG. 2B). The textured surface may be part of a microarray substrate.

The methods of the present invention feature activating the textured surface by creating energetic moieties on the surface that allow for binding of a biomolecule (e.g. probes). The methods may comprise treating the textured surface with electromagnetic radiation (e.g., UV light) or plasma as described herein. However, the present invention is not limited to electromagnetic radiation (e.g., UV light) or plasma for surface activation/creation of energetic moieties. The present invention also includes any other appropriate surface activation method. The activated textured substrates of the present invention may result in improved sensitivity in diagnostic tests. In some embodiments, the methods of the present invention feature reducing the hydrophobicity of the textured surface to allow biomolecule binding.

The present invention features an activated textured surface comprising a plurality of energetic moieties on or within microstructures of the activated textured surface. The activated textured surface may be a feature of a microarray substrate (e.g., the microarray substrate comprises the activated textured surface), or the activated textured surface may be independent of a microarray substrate or a feature of a different type of substrate. The microstructures in the activated textured surface provide an increase in surface area as compared to a surface without microstructures. At least a portion of the microstructures comprises energetic moieties adapted to bind a biomolecule (e.g., an oligonucleotide, an amino acid, a peptide such as an antibody or fragment thereof, a carbohydrate, a lipid, or a combination thereof).

The biomolecule may be bound to the microstructure directly via the energetic moiety. In some embodiments, a linker molecule is bound to the energetic moiety, and a biomolecule is bound to the linker molecule (e.g., a silane molecule).

In some embodiments, the microarray further comprises microfeatures that are larger features than the microstructures. The microfeatures provide an increase in surface area as compared to a surface without microfeatures. The microstructures of the textured surface may be disposed in and/or between the microfeatures. The microfeatures may comprise energetic moieties adapted to bind a biomolecule.

In some embodiments, the activated textured surface comprises microstructures and not necessarily microfeatures. In some embodiments, the activated textured surface comprises microfeatures and not necessarily microstructures. In some embodiments, the activated textured surface comprises both microfeatures and microstructures. In some embodiments, the activated textured surface with microfeatures may be a feature of a microarray substrate (e.g., the microarray substrate comprises the activated textured surface), or the activated textured surface with microfeatures may be independent of a microarray substrate or a feature of a different type of substrate.

The microfeatures and/or microstructures may be distributed uniformly or randomly on the activated textured surface. In some embodiments, the microstructures are at least 10 nm apart. In some embodiments, the activated textured surface is a part of a surface of a slide, plate, microarray well, or a well of a multi-well plate.

The energetic moieties comprise a reactive species capable of binding biomolecules. In some embodiments, the reactive species comprises reactive oxygen species, a hydroxyl, an amine, a carboxyl, an aldehyde, an epoxy, or a combination thereof.

The activated textured surfaces of the present invention are created by treating textured surfaces with electromagnetic radiation or plasma to generate the energetic moieties on the textured surfaces, thereby creating activated textured surfaces. For example, the present invention features a method of preparing an activated textured surface comprising energetic moieties adapted to attach a biomolecule. In some embodiments, the method comprises exposing a textured surface (e.g., with microstructures and/or microfeatures) to electromagnetic radiation (e.g., ultraviolet light) or plasma, wherein the electromagnetic radiation (e.g., ultraviolet light) or plasma activates surface molecules of the microstructures and/or microfeatures to yield energetic moieties adapted to bind biomolecules.

In some embodiments, the ultraviolet light is a wavelength of 400 nm or less, 270 nm or less, 185 nm or less, from 185 nm to 400 nm, etc. In some embodiments, the ultraviolet light is used in combination with a gas (e.g., a gas comprising air, ozone, oxygen, nitrogen, nitrogen-hydrogen mixture, ammonia, argon, water vapor, or a combination thereof). In some embodiments, the plasma comprises atmospheric plasma or vacuum plasma.

Any feature or combination of features described herein are included within the scope of the present invention provided that the features included in any such combination are not mutually inconsistent as will be apparent from the context, this specification, and the knowledge of one of ordinary skill in the art. Additional advantages and aspects of the present invention are apparent in the following detailed description and claims.

### BRIEF DESCRIPTION OF THE DRAWINGS

The features and advantages of the present invention will become apparent from a consideration of the following detailed description presented in connection with the accompanying drawings in which:

FIG. 1A shows a flat surface (for comparison purposes).

FIG. 1B and FIG. 1C show textured surfaces comprising microfeatures (110).

FIG. 1D shows a textured surface comprising microfeatures (110) with microstructures (120) in and between the microfeatures (110). Note the microfeatures can create cavities, e.g., with microstructures at the bottom and/or on the side of the cavity. Note that microstructures may be on the top of the microfeatures as well as on the side (and also in between the microfeatures).

FIG. 1E shows a textured surface comprising microstructures (120).

FIG. 2A shows a well (105) with microstructures (120) disposed on the bottom surface of the well. A well may refer to a well in a microarray substrate or any other appropriate well such as a well of a multi-well plate.

FIG. 2B shows a well (105) with both microfeatures (110) and microstructures (120) disposed on the bottom surface of the well.

FIG. 3A shows a detailed view of microstructures (120) (but may also represent microfeatures (110)).

FIG. 3B shows the microfeatures/microstructures (110, 120) of FIG. 3A displaying energetic moieties (260).

FIG. 3C shows the microfeatures/microstructures (110, 120) of FIG. 3B with biomolecules (310) (e.g., oligonucleotides) bound to the surface via the energetic moieties (260).

### DETAILED DESCRIPTION OF THE INVENTION

A microarray is a general term for a typically smooth, flat surface of a substrate wherein a plurality of distinct and separate locations upon the surface of the substrate is established at the start of the analysis by populating each of the locations with biomolecules (probes) of a known composition. The probes are fixed to their unique locations on the flat substrate by an attachment layer that prevents detachment of the probes from the substrate. After a number of processing steps, the entire microarray is flooded with biomolecules of unknown composition (targets). When a target is captured by a bound probe, it may be possible infer the nature and composition of the target. The sensitivity of this process is limited by the number of probe-target complexes within each specific location on the microarray. In some cases, a microarray may feature a plurality of small wells (e.g., as described in Examples 1-4 below).

A multi-well plate is a single plate-like device with a number of depressions (wells) in it surface, e.g., 96 wells, 384 wells, etc. Multi-well plates are used for a variety of parallel analyses, including but not limited to the process described for the microarray above.

As used herein, a biomolecule may refer to an oligonucleotide (e.g., DNA, RNA), protein or peptide (e.g., antibody, antigen), lipid, carbohydrate or other molecule found in biological entities (e.g., a peptide nucleic acid, a fatty acid, a vitamin, a cofactor, a purine, a pyrimidine, formysin, a phytochrome, a phyyofluor, or phycobiliprotein, etc.) or entire biological entities (e.g., a virus, a phage, a prion a bacteria, etc.). The present invention is not limited to the aforementioned biomolecules.

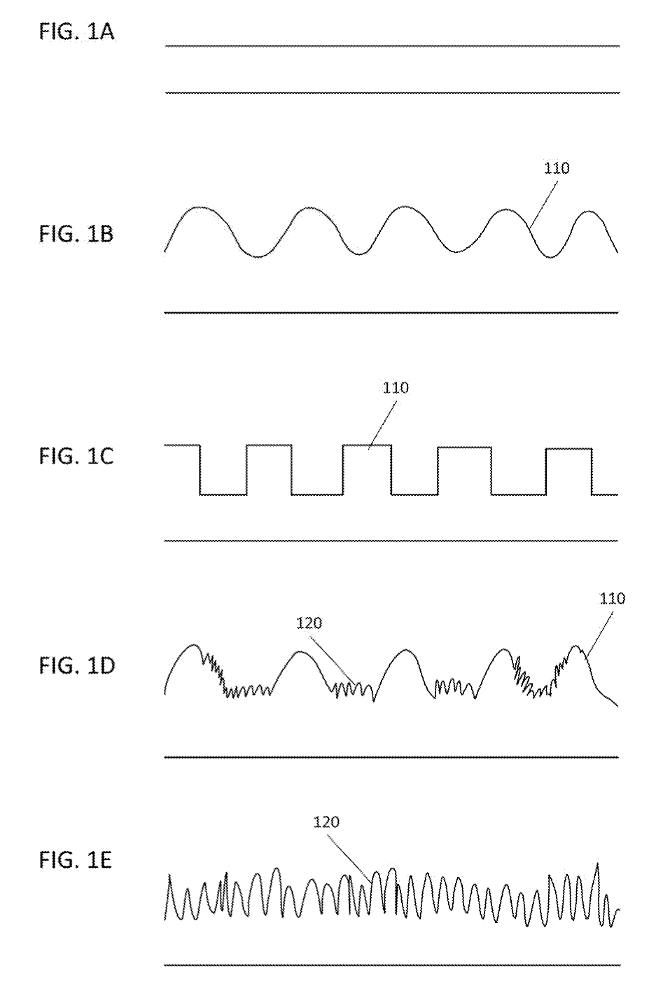

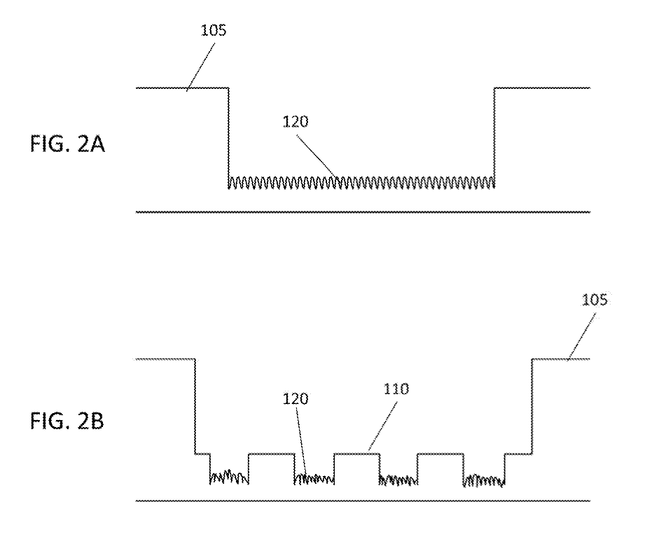

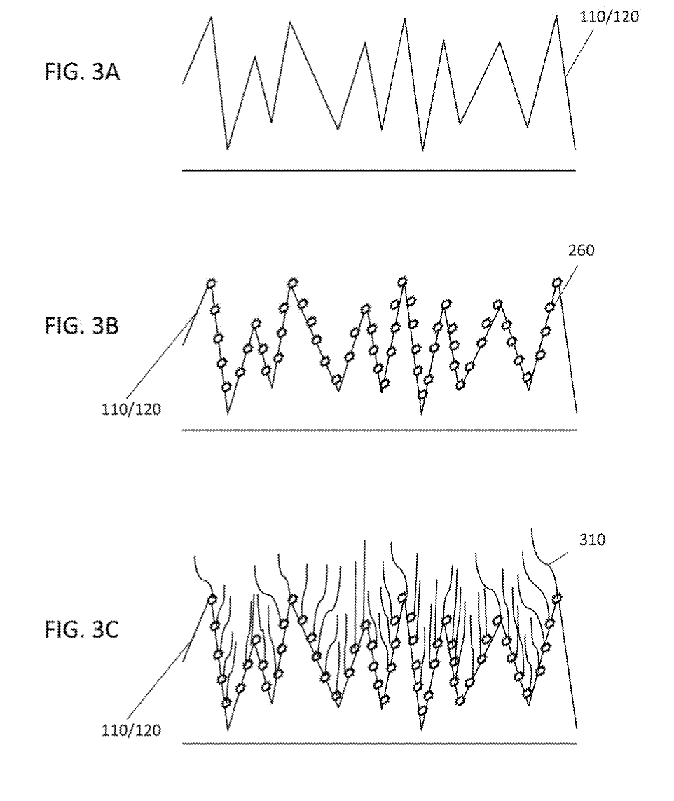

A textured surface or a textured substrate, as used herein, refers to a surface with microfeatures and/or smaller microstructures that increase the surface area as compared to a surface without microfeatures and/or microstructures (e.g., a flat, non-textured surface). The smaller microstructures may be disposed in or between (or both in and between, e.g., on sides of, etc.) the microfeatures (see FIG. 1D, FIG. 2B). A textured surface may comprise microfeatures without microstructures (see FIG. 1B, FIG. 1C). A textured surface may comprise microstructures without microfeatures (see FIG. 1E and FIG. 2A). The textured surface may be part of a microarray substrate. Without wishing to limit the present invention to any theory or mechanism, it is believed that the use of a textured surface is advantageous because the textured surface has a substantial increase in surface area as compared to a flat, non-textured surface. The three dimensional nature of the textured surface can take many forms (as shown in FIG. 1B, FIG. 1C, FIG. 1D, FIG. 1E, FIG. 2A, FIG. 2B). The microfeatures (and/or microstructures) may exhibit large values of height to width (aspect ratio). The high aspect ratio may be an indicator to performance of the structured surface, e.g., the higher the aspect ratio, the more area that is made available. U.S. Pat. No. 7,195,872 and EP No. 1,451,584, the disclosures of which are incorporated in their entirety herein by reference, describe example of textured surfaces comprising a tessellating pattern of microfeatures, some of which comprise even smaller sized features (microstructures). The microfeatures and/or microstructures may comprise a pit, a trench, a pillar, a cone, a wall, a micro-rod, a tube, a channel, the like, or a combination thereof. The present invention is not limited to the patterning described therein.

The present invention features an activated textured surface (e.g., a microarray substrate comprising an activated textured surface), wherein the activated textured surface comprises a plurality of microfeatures and/or smaller microstructures that comprise energetic moieties adapted to bind biomolecules. The microfeatures and/or microstructures provide an increase in surface area as compared to a textured surface without microfeatures and/or microstructures. The smaller microstructures may be disposed in at least a portion of the microfeatures. The smaller microstructures may be disposed between at least a portion of the microfeatures. At least a portion of the microfeatures and/or microstructures comprise energetic moieties adapted to bind a biomolecule.

The microfeatures (or microstructures) may be distributed uniformly or randomly on the textured surface. The microfeatures may have a height from 0.1 μm to 100 μm, e.g., 100 μm, 90 μm, 80 μm, 70 μm, 60 μm, 50 μm, 40 μm, 30 μm, 20 μm, 10 μm, 1 μm, 0.5 μm, 0.1 μm, etc. In some embodiments, the microfeatures have a cross section (or an average cross section) from 0.01 μm² to 500 μm². The microfeatures may be at least 1 micron apart. In some embodiments, the microfeatures may be at least 5 microns apart. In some embodiments, the microfeatures are at least 10 microns apart. In some embodiments, the microfeatures are at least 15 microns apart. In some embodiments, the microfeatures are at least 20 microns apart. In some embodiments, the microfeatures are at least 50 microns apart. In some embodiments, the microfeatures are at least 100 microns apart. In some embodiments, the microfeatures are less than 500 microns apart. In some embodiments, the microfeatures are less than 500 microns apart. In some embodiments, the microfeatures are less than 100 microns apart. In some embodiments, the microfeatures are less than 50 microns apart. In some embodiments, the microfeatures are less than 20 microns apart. In some embodiments, the microfeatures are less than 10 microns apart. In some embodiments, the microfeatures are less than 5 microns apart.

As previously discussed, the microfeatures may exhibit large values of aspect ratio (height to width). Also, the aspect ratios of the various microfeatures may differ. In some embodiments, the microfeatures have an average aspect ratio of less than 25 (height divided by an average cross sectional width), or the microfeatures may each have an aspect ratio of less than 25. In some embodiments, the microfeatures have an average aspect ratio of less than 10 (height divided by an average cross sectional width), or the microfeatures may each have an aspect ratio of less than 10. In some embodiments, the microfeatures have an average aspect ratio of less than 5 (height divided by an average cross sectional width), or the microfeatures may each have an aspect ratio of less than 5. In some embodiments, the microfeatures have an average aspect ratio of less than 1 (height divided by an average cross sectional width), or the microfeatures may each have an aspect ratio of less than 1. The present invention is not limited to the aforementioned aspect ratio values.

Note the present invention is not limited to textured surfaces with microfeatures: in some embodiments the textured surface comprises only the smaller microstructures (e.g., see FIG. 1E, FIG. 2A). In some embodiments, the microstructures may be disposed in the microfeatures and/or between the microfeatures (e.g., see FIG. 1D, FIG. 2B). In some embodiments, the textured surface comprises only microfeatures (see FIG. 1B, FIG. 1C).

The microstructures may have a height less than 5 μm, e.g., 4 μm, 3 μm, 2 μm, 1 pm, etc. In some embodiments, the microstructures have a height less than 1 μm. In some embodiments, the microstructures have a height from 5 μm to 0.1 μm. In some embodiments, the microstructures have an average aspect ratio of less than 25 (height divided by an average cross sectional width), or the microstructures may each have an aspect ratio of less than 25. In some embodiments, the microstructures have an average aspect ratio of less than 10 (height divided by an average cross sectional width), or the microstructures may each have an aspect ratio of less than 10. In some embodiments, the microstructures have an average aspect ratio of less than 5 (height divided by an average cross sectional width), or the microstructures may each have an aspect ratio of less than 5. In some embodiments, the microstructures have an average aspect ratio of less than 1 (height divided by an average cross sectional width), or the microstructures may each have an aspect ratio of less than 1. The present invention is not limited to the aforementioned aspect ratio values.

The microstructures may less than 500 nm apart. In some embodiments, the microstructures are less than 100 nm apart. In some embodiments, the microstructures are less than 50 nm apart. In some embodiments, the microstructures less than 20 nm apart. The microstructures may be at least 20 nm apart. In some embodiments, the microstructures may be at least 50 nm apart. In some embodiments, the microstructures are at least 100 nm apart. In some embodiments, the microstructures are at least 500 nm apart.

The presence of the microfeatures may increase the surface area of the textured surface at least 10% as compared a surface without the microfeatures. The presence of the microfeatures may increase the surface area of the textured surface at least 50% as compared to a surface without the microfeatures. The presence of the microfeatures may increase the surface area of the textured surface at least 100% as compared to a surface without the microfeatures. The presence of the microfeatures may increase the surface area of the textured surface at least 200% as compared to a surface without the microfeatures. The presence of the microstructures may increase the surface area of the textured surface at least 10% as compared a surface without the microstructures. The presence of the microstructures may increase the surface area of the textured surface at least 50% as compared to a surface without the microstructures. The presence of the microstructures may increase the surface area of the textured surface at least 100% as compared to a surface without the microstructures. The presence of the microstructures may increase the surface area of the textured surface at least 200% as compared to a surface without the microstructures.

Importantly, the presence of energetic moieties on the microfeatures and/or microstructures does not reduce the surface area of the microfeatures, microstructures, and/or activated textured surface. Treatment by plasma, intended to create energetic moieties, may also increase the surface area by removing substrate from the textured substrate

Referring to FIG. 1D and FIG. 2B, the microfeatures may form cavities, wherein microstructures are disposed in the cavities. The cavities may be adapted to retain liquid.

As previously discussed, the activated textured surface may be a part of a microarray substrate. Or, the textured surface may be a feature of a spherical surface, a rod surface, a flexible film surface, a foil surface, or other appropriate surface. As such, in some embodiments, the activated textured surface is a part of a slide, a plate, a well (e.g., a well of a multi-well plate, a well of a microarray substrate), or any other appropriate surface for attaching biomolecules. The activated textured surface may cover a portion of the microarray substrate (or other surface on which the activated texture surface lies). In some embodiments, the activated textured surface covers all of the microarray substrate (or other surface on which the activated texture surface lies).

As previously discussed, the present invention also features methods producing the activated textured substrates of the present invention. For example, the methods feature activating textured substrates such that the textured substrates are adapted to bind biomolecules, e.g., the textured substrates are activated to yield energetic moieties on the surface of microfeatures and/or microstructures. In some embodiments, the method features reducing the hydrophobicity of the textured surface.

The textured surface may be constructed from a material comprising a polymer material, a glass, a ceramic, a metal, the like, or a combination thereof. Polymers may include but are not limited to cyclic olefin copolymer (COC), polyethylene terephthalate (PET), polymethyl methacrylate (PMMA), polystyrene, the like, or a combination thereof.

The textured surface is exposed to electromagnetic radiation (e.g., UV light) or plasma, wherein the electromagnetic radiation (e.g., UV light) or plasma activates surface molecules of the microfeatures and/or microstructures yielding energetic moieties adapted to bind biomolecules, thereby creating an activated textured surface. Note the present invention is not limited to electromagnetic radiation (e.g. UV light) or plasma for surface activation/creation of energetic moieties. The present invention also includes any other appropriate surface activation method. Biomolecules may comprise oligonucleotides, amino acids, peptides/proteins, carbohydrates, lipids, or combinations thereof. As an example, the peptide may be an antibody or a fragment thereof.

Electromagnetic radiation treatment may feature exposure to a dose of UV light in the presence of a gas. The gas may comprise air, ozone, oxygen, nitrogen, nitrogen-hydrogen mixture, ammonia, an inert gas (e.g., argon), water vapor, the like, or a combination thereof. The selection of the gaseous material enables different species of energetic moieties to be created on the surface. Thus, the present invention allows for tailoring the binding surfaces (e.g., via gas selection) to match the nature of the incoming probe biomolecule. It will be appreciated that other means of creating these energetic moieties on the surface of the textured substrate are included in the scope of this invention. For example, the use of ozone may establish hydroxyl species on the surface; the use of nitrogen, nitrogen/hydrogen, or ammonia gases may establish amine species on the surface.

In some embodiments, the method comprises exposing the textured surface (e.g., microarray substrate) to UV light in the presence of air. In some embodiments, the method comprises exposing the textured surface (e.g., microarray substrate) to UV light in the presence of ozone. In some embodiments, the method comprises exposing the textured surface (e.g., microarray substrate) to UV light in the presence of oxygen. In some embodiments, the method comprises exposing the textured surface (e.g., microarray substrate) to UV light in the presence of a nitrogen-hydrogen mixture. In some embodiments, the method comprises exposing the textured surface (e.g., microarray substrate) to UV light in the presence of nitrogen. In some embodiments, the method comprises exposing the textured surface (e.g., microarray substrate) to UV light in the presence of ammonia. In some embodiments, the method comprises exposing the textured surface (e.g., microarray substrate) to UV light in the presence of an inert gas (e.g., argon). In some embodiments, the method comprises exposing the textured surface (e.g., microarray substrate) to UV light in the presence of water vapor.

Doses may be from 25 to 1500 millijoules, e.g., 50 millijoules, 100 millijoules, 150 millijoules, 200 millijoules, from 25 to 100 millijoules, from 50 to 200 millijoules, from 100 to 500 millijoules, from 500 to 1500 millijoules, etc.

Wavelengths of UV light that may be used may include a wavelength of 400 nm or less, 300 nm or less, 200 nm or less, 185 nm or less, etc., to about 100 nm. For example, in some embodiments, the wavelength is about 185 nm. In some embodiments, the wavelength is from 185 nm to 260 nm. In some embodiments, the wavelength is from 250 nm to 400 nm.

In some embodiments, the method comprises a second exposure to electromagnetic radiation (e.g., UV light). In some embodiments, the method further comprises a third or fourth exposure to electromagnetic radiation (e.g., UV light).

Plasma treatment may feature the use of atmospheric plasma or vacuum plasma.

Without wishing to limit the present invention to any theory or mechanism, plasma may be chosen over ultraviolet light as it may be easier to use different gases to create tailored chemistries in the energetic moieties and the plasma process produces less heat in the textured substrate.

As an example, in some embodiments, the plasma treatment comprises exposing the textured substrate to plasma within a chamber (e.g., a chamber with electrodes adapted to generate a plasma environment). Plasma may include but is not limited to oxygen plasma, nitrogen plasma, plasma from oxygen and an inert gas (e.g., argon/oxygen plasma), nitrogen-hydrogen plasma, water vapor, or plasma from various other gases or combinations of gases.

The energetic moieties created by activation (e.g., exposure to electromagnetic radiation or plasma) are reactive species capable of binding biomolecules. Reactive species may include but are not limited to reactive oxygen species, a hydroxyl, an amine, a carboxyl, an aldehyde, an epoxy, the like, or a combination thereof.

While the methods of the present invention allow biomolecules to be directly attached to the textured surface, linker molecules may still be used. For example, linker molecules may be bound to the energetic moieties, and biomolecules (e.g. probes) may then be bound to the linker molecules.

Without wishing to limit the present invention to any theory or mechanism, it is believed that the methods, systems, and compositions of the present invention may allow for enhanced signals and/or better results when used for diagnostic or other purposes.

Without wishing to limit the present invention to any theory or mechanism, it is believed that the methods, systems, and compositions of the present invention are advantageous because they allow for the use of unmodified biomolecule probes.

The examples below (Examples 1, 2, 3, and 4) describe various methods for attaching biomolecules to textured surfaces. The methods of the present invention pertain mainly to Examples 3 and 4, wherein the textured surfaces are activated using either UV light or plasma.

### EXAMPLE 1

### Dip Coating of Textured Microarray Slide

Example 1 describes the dip coating of a textured microarray slide with a silane derivative and subsequent evaluation of oligonucleotide attachment/availability. The present invention is not limited to the methods and compositions herein.

A microarray of standard form factor (e.g., 25 mm×75 mm) molded in COC was used. The microarray surface was comprised of wells with dimensions of approximately 15 microns by 15 microns (see FIG. 2A, which shows a side cross sectional view of a well with microstructures covering the bottom surface of the well). In this example, the wells formed a tessellating pattern across substantially all the surface of the microarray surface. Within each well, a large number of high aspect ratio microstructures serve to increase the available surface area (when compared to a similar sized flat microarray substrate). The textured slides were manufactured by a combination of molding and embossing by Stratec Consumables (Anif, Austria).

Six of these textured microarray slides and six non-textured microarray slides were dipped into a solution of ethanol and 3-glycidoxypropyltrimethoxysilane (2% by weight). The slides were dipped in a vertical direction and withdrawn slowly (e.g., approximately 5 seconds). The slides were held horizontally for a further 10 seconds. The slides were placed on a metal wire rack in a clean, sealed chamber. The ambient temperature was 22 C. The slides were allowed to dry overnight. The slides were printed with a 25 mer oligonucleotide (the attachment end was not modified). A percentage of the 25 mer oligonucleotide had Cy5 dye molecules attached to the non-attached end.

All the microarrays were then scanned using a GenePix 4000B scanner and the images were stored for further analysis. The microarrays were then washed and dried and scanned again. The wash solution comprised 0.2×SSC (saline sodium citrate) with water. The PMT gain on the Green channel was 400. The PMT gain on the Red Channel was 700.

Both sets of slides were placed into a hybridization chamber and exposed to a solution of compatible oligonucleotides, a fraction of which were labeled with Cy3 dye molecules. The hybridization protocol was one of many standard methods widely used in the microarray analysis laboratories. After two washing cycles, all the microarray substrates were dried and again scanned in the GenePix scanner.

An analysis of the images showed that the textured substrates exhibited a minor improvement (e.g., an average of 2× times better) in integrated intensity when compared to the non-textured substrates.

### EXAMPLE 2

### Vapor Phase Coating of Textured Microarray Slide

Example 2 describes the vapor coating of a textured microarray slide with a silane derivative and subsequent evaluation of oligonucleotide attachment/availability. The present invention is not limited to the methods and compositions herein.

A microarray of standard form factor (e.g., 25 mm×75 mm) molded in COC was used. The texture was comprised of wells with dimensions of approximately 15 microns by 15 microns (see FIG. 2A, which shows a side cross sectional view of a well with microstructures covering the bottom surface of the well. The wells formed a tessellating pattern across substantially all the surface of the microarray surface. Within each well, a large number of high aspect ratio microstructures serve to increase the available surface area (when compared to a similar sized flat microarray substrate). The textured slides were manufactured by a combination of molding and embossing by Stratec Consumables (Anif, Austria).

Five textured slides and five non-textured slides were cleaned with ethanol (Fisher Scientific) and allowed to dry in a closed oven at room temperature. All the slides were attached to an aluminum sheet using adhesive tape. The slides were retained in place using tape covering the extreme (short) edges of the microarray slides.

The plate carrying the slides was suspended (with the slides facing down) in a small vacuum chamber (manufacturer ThermoFisher Model 3628A). The oven temperature was set and maintained at 70 C. The vacuum oven was connected to an Edwards RV Roughing Pump (Model RV3) capable of quickly reaching vacuum levels of less than 0.1 millitorr. The interior of the oven had been thoroughly cleaning with ethanol and wipes that do not produce fibrous debris. Exhaust from the oven passes through a trap.

A small glass Petrie dish was cleaned using ethanol and rinsed in distilled water and allowed to dry. A solution of p-xylene and 3-glycidoxypropyltrimethoxysilane (equal parts by weight) was prepared. Approximately 1 ml of the solution was placed on the surface of the Petrie dish. The dish was quickly placed on the floor of the oven, the door closed and vacuum pumping was engaged. The time to approximately 1 millitorr was approximately 20 seconds. The pumping continued for about 5 more minutes. The pump was shut off and the pressure was allowed to return to normal levels using a small bleed valve. Air entering the oven was passed through a simple filter to remove airborne particulates.

The Petri dish was completely dry indicating that it had flash evaporated and that the vapor (carrying the epoxysilane) had filled the chamber and that the slides had been exposed to the vapor. The slides were removed after allowing a cooling period.

The slides were printed with a 20 mer oligonucleotide (the attachment end was not modified). A percentage of the 20 mer oligo had Cy5 dye molecules attached to the non-attached end. Five dilutions were prepared (the 5^{th} dilution was 0.01× the first dilution) and the print pattern comprised a 5 by 3 pattern. The five line represented the dilutions. The three columns were to be used for replication.

All the microarrays were then scanned using a GenePix 4000B scanner and the images stored for further analysis. The microarrays were then washed and dried and scanned again. The wash solution comprised 0.2× SSC with water. The PMT gain on the Green channel was 400. The PMT gain on the Red Channel was 700.

Both sets of slides were placed into a hybridization chamber and exposed to a solution of compatible oligonucleotides a fraction of which were labeled with Cy3 dye molecules. The hybridization protocol was one of many standard methods widely used in the microarray analysis laboratories. After two washing cycles, the textured microarray substrates were dried and again scanned in the GenePix scanner.

An analysis of the images showed that the textured substrates exhibited an improvement (e.g., average of 8× better) in integrated intensity when compared to the non-textured substrates. The spots containing the lowest dilutions of oligonucleotides showed higher increases in intensity (approximately 10×).

### EXAMPLE 3

### UV Treatment of Textured Microarray Slide

Example 3 describes the UV treatment of a textured microarray slide and subsequent evaluation of oligonucleotide attachment/availability. The present invention is not limited to the methods and compositions herein.

A microarray of standard form factor (e.g., 25 mm×75 mm) molded in COC was used. The texture was comprised of wells with dimensions of approximately 15 microns by 15 microns (see FIG. 2A, which shows a side cross sectional view of a well with microstructures covering the bottom surface of the well). The wells formed a tessellating pattern across substantially all the surface of the microarray surface. Within each well, a large number of high aspect ratio microstructures serve to increase the available surface area (when compared to a similar sized flat microarray substrate). The textured slides were manufactured by a combination of molding and embossing by Stratec Consumables (Anif, Austria).

Six textured microarrays (and two non-textured slides were included for the purposes of comparison) were exposed to UV (in the presence of air) using a Stratalinker device (Model Number 1800). The base dose was 150 millijoules at a wavelength of 254 nm. After dosing, the slides were printed with a 20 mer oligonucleotide (the attachment end was not modified). A percentage of the 20 mer oligo had Cy5 dye molecules attached to the non-attached end. Five different dilutions were used in order to assess the dynamic range of the substrate.

After printing, three of the textured microarrays (and one non-textured slide) were exposed to a further dose of UV (again in the presence of air). The purpose was to crosslink the 20 mer oligomers to each other. The conglomerate was anchored to the surface by those oligomers that were captured by the energetic moieties created by the UV. This post-print crosslinking process is widely used. The remaining three textured microarrays and one remaining non-textured slide were not exposed to this process.

All the microarrays were then scanned using a GenePix 4000B scanner and the images stored for further analysis. The microarrays were then washed, dried and scanned again. The wash solution comprised 0.2× SSC with water. The PMT gain on the Green channel was 400. The PMT gain on the Red Channel was 700.

Both sets of slides were placed into a hybridization chamber and exposed to a solution of 100% complementary oligonucleotides a fraction of which were labeled with Cy3 dye molecules. The hybridization protocol was one of many standard methods widely used in the microarray analysis laboratories. After two washing cycles, the textured microarray substrates were dried and again scanned in the GenePix scanner.

An analysis of the images showed that the textured substrates exhibited a substantial improvement (e.g., an average of 16 times better) in integrated intensity when compared to the non-textured substrates. The textured substrates (and one non-textured substrate) that had received a post-printing dose of UV exhibited an even larger improvement (e.g., an average 26 times better) when compared to the substrates that had received no post-printing exposure to UV. It should be noted that the images were rectangular in shape. The improvement was most marked at the lower dilutions.

### EXAMPLE 4

### Plasma Treatment of Textured Microarray Slide

Example 4 describes the plasma treatment of a textured microarray slide and subsequent evaluation of oligonucleotide attachment/availability. The present invention is not limited to the methods and compositions herein.

A microarray of standard form factor (e.g., 25 mm×75 mm) molded in COC was used. The texture was comprised of wells with dimensions of approximately 15 microns by 15 microns (see FIG. 2A, which shows a side cross sectional view of a well with microstructures covering the bottom surface of the well). The wells formed a tessellating pattern across substantially all the surface of the microarray surface. Within each well, a large number of high aspect ratio microstructures serve to increase the available surface area (when compared to a similar sized flat microarray substrate). The textured slides were manufactured by a combination of molding and embossing by Stratec Consumables (Anif, Austria).

Textured substrates and non-textured substrates were placed in an Edwards Vacuum Chamber equipped with electrodes capable of generating a plasma environment within the chamber. These were exposed to argon/oxygen plasma under several different conditions (e.g., time, gas flow, etc.). Simple contact angle measurements indicated that exposure did alter the surface energy of the COC polymer substrates.

After the plasma treatment, the slides were printed with a 20 mer oligonucleotide (the attachment end was not modified). A percentage of the 20 mer oligo had Cy5 dye molecules attached to the non-attached end. Five different dilutions were used in order to assess the dynamic range of the substrate.

All the microarrays were then scanned using a GenePix 4000B scanner and the images stored for further analysis. The microarrays were then washed, dried and scanned again. The wash solution comprised 0.2× SSC with water. The PMT gain on the Green channel was 400. The PMT gain on the Red Channel was 700.

Both sets of slides were placed into a hybridization chamber and exposed to a solution of 100% complementary oligonucleotides a fraction of which were labeled with Cy3 dye molecules. The hybridization protocol was one of many standard methods widely used in the microarray analysis laboratories. After two washing cycles, the textured microarray substrates were dried and again scanned in the GenePix scanner.

The textured slides showed increases in image intensity exceeding 21 times that of the non-textured substrate.

The disclosures of the following patents are incorporated in their entirety by reference herein: U.S. Pat. No. 7,195,872; EP No. 1,451,584; U.S. Pat. App. No. 2008/0274917; U.S. Pat. No. 7,282,241; U.S. Pat. No. 7,094,451. See also Tsao et al., Lab Chip, 2007, 7:499-505; Sun et al., Anal Bioanal Chem, 2012, 402(2):741-748. McIntyre and Walzak, Modern Plastics, 1995, pp79-85.

Various modifications of the invention, in addition to those described herein, will be apparent to those skilled in the art from the foregoing description. Such modifications are also intended to fall within the scope of the appended claims. Each reference cited in the present application is incorporated herein by reference in its entirety.

Although there has been shown and described the preferred embodiment of the present invention, it will be readily apparent to those skilled in the art that modifications may be made thereto which do not exceed the scope of the appended claims. Therefore, the scope of the invention is only to be limited by the following claims. Reference numbers recited in the claims are exemplary and for ease of review by the patent office only, and are not limiting in any way. In some embodiments, the figures presented in this patent application are drawn to scale, including the angles, ratios of dimensions, etc. In some embodiments, the figures are representative only and the claims are not limited by the dimensions of the figures. In some embodiments, descriptions of the inventions described herein using the phrase “comprising” includes embodiments that could be described as “consisting of”, and as such the written description requirement for claiming one or more embodiments of the present invention using the phrase “consisting of” is met.

The reference numbers recited in the below claims are solely for ease of examination of this patent application, and are exemplary, and are not intended in any way to limit the scope of the claims to the particular features having the corresponding reference numbers in the drawings.

1-25. (canceled)

26. An activated textured surface comprising a plurality of energetic moieties on microstructures of the activated textured surface, the microstructures provide an increase in surface area as compared to a surface without microstructures, wherein at least a portion of the microstructures display an energetic moiety adapted to bind a biomolecule.

27. (canceled)

28. The activated textured surface of claim 26, wherein the microstructures are at least 10 nm apart.

29. The activated textured surface of claim 26, wherein the microstructures are distributed uniformly or randomly on the textured surface.

30. The activated textured surface of claim 26, wherein the microstructures have a height less than 5 microns.

31. (canceled)

32. The activated textured surface of claim 26, wherein the microstructures have an average aspect ratio of less than 25, the aspect ratio being measured as height divided by an average cross sectional width.

33. The activated textured surface of claim 26, wherein the microstructures provide the activated textured surface an increase in surface area of at least 50% as compared to a surface without microstructures.

34. (canceled)

35. (canceled)

36. The activated textured surface of claim 26, wherein the activated textured surface is a part of a surface of a slide, plate, microarray substrate, microarray well, or a well of a multi-well plate.

37. The activated textured surface of claim 26, wherein the microstructure comprises a pit, a trench, a pillar, a cone, a wall, a micro-rod, a tube, a channel or a combination thereof.

38. The activated textured surface of claim 26, wherein the energetic moieties comprise a reactive species capable of binding biomolecules.

39. The activated textured surface of claim 38, wherein the reactive species comprises reactive oxygen species, a hydroxyl, an amine, a carboxyl, an aldehyde, an epoxy, or a combination thereof.

40. The activated textured surface of claim 26, wherein the activated textured surface comprises a polymer material, a glass, a ceramic, a metal, or a combination thereof.

41. The activated textured surface of claim 40, wherein the polymer comprises cyclic olefin copolymer (COC), polyethylene terephthalate (PET), polymethyl methacrylate (PMMA)), polystyrene, or a combination thereof.

42. The activated textured surface of claim 26, wherein the biomolecule comprises an oligonucleotide, an amino acid, a peptide, an antibody or fragment thereof, an antigen, a carbohydrate, a lipid, or a combination thereof.

43. (canceled)

44. The activated textured surface of claim 26, wherein a linker molecule is bound to the energetic moieties, the linker molecule is for attaching a biomolecule.

45. The activated textured surface of claim 26, wherein the activated textured surface has been treated with electromagnetic radiation or plasma to generate the energetic moieties.

46-139. (canceled)

140. A method of preparing an activated textured surface comprising energetic moieties adapted to attach a biomolecule, said method comprising:
exposing to electromagnetic radiation or plasma a textured surface comprising a plurality of microstructures that provide an increase in surface area as compared a surface without microstructures, wherein said electromagnetic radiation or plasma activates surface molecules of the microstructures to display energetic moieties adapted to bind biomolecules thereby creating an activated textured surface.

141. The method of claim 140, wherein electromagnetic radiation comprises ultraviolet light.

142-144. (canceled)

145. The method of claim 141, wherein the ultraviolet is a wavelength from 185 nm to 400 nm.

146. The method of claim 141, wherein the ultraviolet light is used in combination with a gas.

147. The method of claim 146, wherein the gas comprises nitrogen, nitrogen-hydrogen mixture, ammonia, argon, water vapor, or a combination thereof.

148. The method of claim 140, wherein plasma comprises atmospheric plasma or vacuum plasma.

149-159 (canceled)

160. The activated textured surface of claim 26, wherein the activated textured surface is a feature of a spherical surface, a rod surface, a flexible film surface, or a foil surface.

161. The method of claim 148, wherein the plasma comprises nitrogen, an inert gas, water vapor, hydrogen or a combination thereof.
